(19) United States
(12) Patent Application Publication
(10) Pub. No.: US 2004/0187944 A1
(43) Pub. Date: Sep. 30, 2004

(54) Point of use venturi-type chemical pump

(76) Inventor: John T. O'Melia, Towson, MD (US)

Correspondence Address: John T. O'Melia, 614 Coventry Rd., Towson, MD, 21286, US

(21) Appl. No.: 10/393,647

(22) Filed: Mar. 24, 2003

(51) Int. Cl. F17D 1/00

(52) U.S. Cl. 137/893

(57) ABSTRACT

A point-of-use, venturi-type chemical metering pump having a flow constriction that produces a negative pressure condition. Treatment chemical is pumped by this negative pressure condition. A treatment chemical conveyance device (18) and flow control device (16) induce dynamic head losses which determine the flow of chemical for a given negative pressure condition. The negative pressure varies with flow such that flow of treatment chemical varies linearly with flow of untreated liquid or gas. A flow-paced chemical dose is thereby applied to the liquid or gas flow stream.

### BACKGROUND OF THE INVENTION—FIELD OF THE INVENTION

This invention relates to the addition of a flow-paced dose of a chemical to water at the tap such as the addition of liquid chlorine (especially sodium hypochlorite), or other treatment chemical at a drinking water tap, community potable water tap or well head.

### BACKGROUND OF THE INVENTION

Chlorine has been used to disinfect potable water supplies since the early 1900's and has chlorination is the treatment technique cheifly responsible for the control of waterborne disease throughout the developed world. Although chlorine is inexpensive and available throughout the developing world [in the form of bleach (dilute sodium hypochlorite)], point-of-use devices are not available to allow untrained personnel to apply an appropriate dose at the point of use, (especially community taps which are the primary potable water supply for the poorest citizens in the developing world).

Because of variation in manufacturing processes and degradation in transport and storage, the concentration of chlorine in commercially available bleach varies significantly. Containers used by consumers to convey water from these community taps are often somewhat unsanitary as are the conditions in which consumers store the water. These conditions cause significant variation in the chlorine demand of the stored water and the residual chlorine required to maintain sanitary condition. Because of these varying conditions, the precision of dose afforded by standard chlorination equipment is of little value in such an application. Standard chlorination equipment also requires operation and maintenance skills that are often unavailable in underdeveloped areas of the world.

This invention represents a robust, reliable method for providing a suitable chlorine dosage with little technical expertise required for installation, operation, and maintenance.

There are innumerable similar situations where reliability and robustness of dosage are more important than the precision of the dose applied and where little or no installation, operation and maintenance skills are available. These situations exist in water and wastewater treatment, industrial applications, agricultural systems and many other activities.

### BACKGROUND OF INVENTION—OBJECTS AND ADVANTAGES

This invention is a system for adding a chemical to a liquid stream by inducing a vacuum condition. The vacuum condition is induced by passing the flow through an orifice that increases flow velocity and thus creates a negative pressure condition (e.g. venturi device or orifice plate). This negative pressure condition is used to pump the treatment chemical. The pressure will vary depending on the main flow stream, and the driving pressure will vary similarly. Dynamic head loss will be induced in the chemical conveyance system by piping, tubing, penetrations, fittings and/or flow control devices, which may or may not include valves or backflow preventers. Accordingly, several objects and advantages of my invention are:

a. the volume of chemical applied will vary depending on the volumetric flow of water (or other liquid or gas stream) thereby maintaining a relatively consistent chemical dose over a range of flows,

b. little technical skills are required by the purchaser, installer, maintenance personnel, or user of the device, and

c. the device is simple and economical enough to be applied in many point of use applications in the developed or developing world.

### SUMMARY

In accordance with the present invention, a venturi-type chemical metering pump comprises a flow constriction which increases flow velocity whereby a negative pressure condition is induced, and a chemical flow conveyance device which induces a dynamic headloss whereby treatment chemical is induced at the point of negative pressure and the flow of treatment chemical will vary with the main flow.

### DRAWING—FIGS.

FIG. 1 is an orthogonal view of my invention with a cut-away showing the internal orifice plate.

FIG. 2 is a perspective side view of my invention.

FIG. 3 is a section side view of my invention showing the internal features.

FIG. 4 is a view in detail of the portion indicated by section lines 4-4 in FIG. 3.

### DRAWINGS—LIST OF REFERENCE NUMERALS

10—point of attachment to the tap or (if applied in-line) attachment to the upstream piping

12—orifice plate

13—orifice

14—opening for chemical induction

16—chemical flow control device

18—chemical conveyance tubing

20—180-degree bend to maintain trap

22—180-degree bend to maintain trap

24—point of discharge or (if applied in-line) attachment to downstream piping

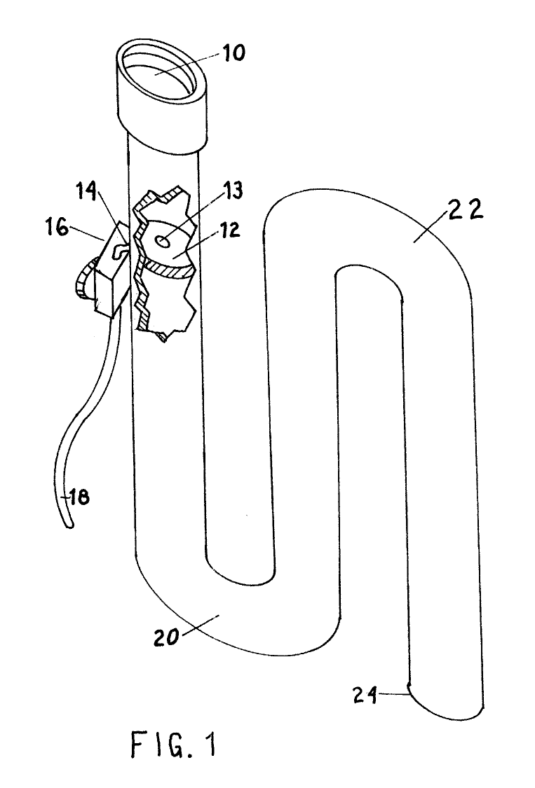

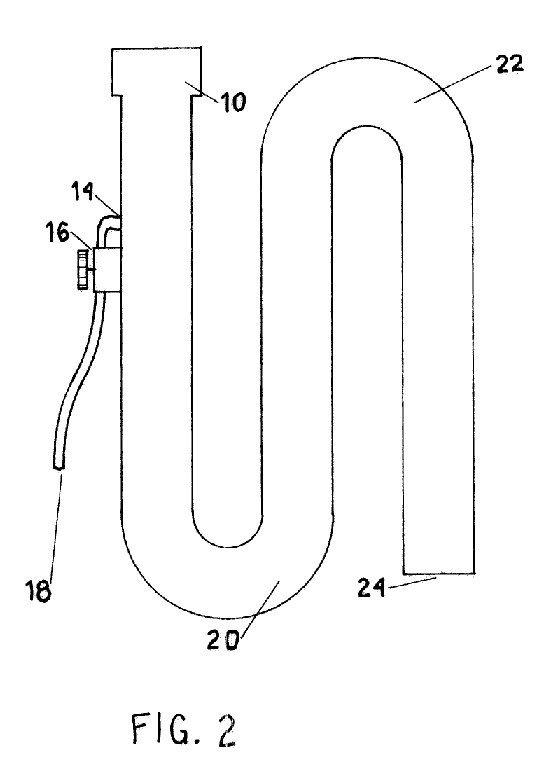

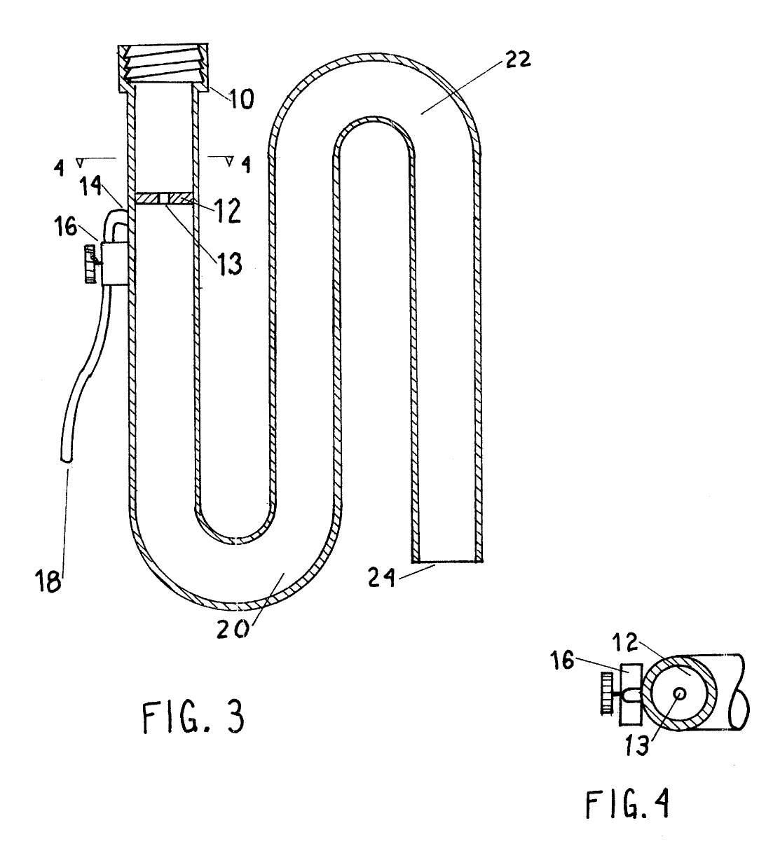

### DETAILED DESCRIPTION—FIGS. 1-4—PREFERRED EMBODIMENT

Referring initially to FIG. 1, the invention includes an orifice-type vacuum pump that attaches to a tap discharging untreated fluid or gas, shown at 10. Referring to FIG. 1, within this pump, a flow constriction (orifice plate, venturi tube, or similar) (depicted at 13) increases flow velocity, thus creating a negative pressure condition. As the flow is varied, the negative pressure will vary. This varying pressure is the driving head for pumping the treatment chemical. The change in pressure will vary with the square of the change in flow. (For example, doubling the flow will cause a four-fold increase in the driving head.)

A penetration (14) just downstream of this flow constriction allows induction of treatment chemical driven by the varying negative pressure. The orifice (13) is sized to provide a particular range of vacuum pressures at a given range of flows. A tube, pipe or similar conveyance device (18) will convey treatment chemical from a reservoir into the pump.

Flow of chemical is controlled by the flow-paced variation in negative pressure and the headloss inducing flow control device (16). This device may or may not be adjustable. A control device, which obstructs flow inducing a dynamic loss in head, provides a flow-paced dose under the varying pressure condition. The chemical flow will vary with the square root of the driving pressure. (For example, quadrupling the driving pressure will double the chemical flow.) Because the driving head varies with the square of water flow, the volume of treatment chemical induced at 14 will vary linearly with the volumetric flow through the orifice at 13. (For example, doubling the flow of untreated liquid or gas will double the flow of treatment chemical, thereby maintaining a consistent chemical dose.)

The specific configuration of this headloss-inducing device will control the dose. For example, further constriction of chemical flow (for example, by further closing of a flow control valve at 16, use of smaller diameter tubing at 18) will reduce the dose provided under all appropriate flow conditions.

By carefully configuring the constriction in the orifice-type vacuum pump and the headloss inducing flow control device, the point-of-use chemical pump will provide a suitably consistent and appropriate dose under a reasonable range of flow conditions.

A trap is provided by a pair of 180-degree bends (20 and 22) in order to achieve and maintain negative pressure conditions at the chemical injection point (14). The flow of treated liquid or gas is discharged at 24.

A backflow preventing device may be included on the treatment chemical tube (18) to provide more rapid dose-response where the flow may be intermittent.

### OPERATION OF THE INVENTION

The manner of using the venturi-type chemical metering pump to add a treatment chemical to a liquid or gas is to attach the pump to the tap (or, if applied in-line, to the piping) at 10 and place the chemical conveyance tubing (18) in a reservoir of treatment chemical. The reservoir should be placed at an elevation close to the elevation of the point of application (14) in order to minimize static head differences and assure that dynamic headlosses dominate the chemical conveyance system (18, 16, and 14). When flow is introduced through the pump, the vacuum pressure at 14 will be equivalent to the headloss through the chemical conveyance system (18, 16, and 14). The vacuum pressure will vary with flow squared and the flow of chemical will vary with the square root of the driving (vacuum) pressure. The chemical dose will therefore remain approximately and reasonably constant over a range of flows. If an adjustable control device is included at 16 this should be adjusted such that the desired dose is achieved at one flow condition. This dosage will then be approximately constant over a range of flows. If no adjustable control device is provided, the dose will be set by the precise configuration of the pump, orifice, and chemical conveyance system.

### CONCLUSIONS RAMIFICATIONS AND SCOPE

Thus the reader will see that the chemical metering pump of the invention provides a reliable, robust, yet economical device that can be used throughout the developed and developing world by professionals and laypersons alike.

While my above description contains main specifications, these should not be construed as limitations on the scope of the invention, but rather as an exemplification of one preferred embodiment thereof. Many other variations are possible. For example:

a. any flow constriction, including a venturi tube, may be applied at 12 to increase flow and induce negative pressure conditions,

b. any headloss inducing device, including a simple penetration which induces entry losses, whether adjustable or not, may be applied in the treatment chemical conveyance system in order to flow-pace the chemical dose,

c. a check valve may be utilized in the treatment chemical conveyance system in order to flow-pace the chemical and reduce the dose response to changes in flow,

d. the trap (20 and 22) can be deleted from the embodiment, and

e. the device can be applied in line, rather than at the tap.

Thus the scope of the invention should be determined by the appended claims and their legal equivalents, rather than the examples given.

1. A chemical metering device for adding a flow-paced dose of a chemical to a stream comprising:
a. a flow constriction which increases flow velocity whereby a negative pressure condition is induced, and
b. a chemical flow conveyance device which induces a dynamic headloss whereby treatment chemical is induced at the point of negative pressure and the flow of treatment chemical will vary with the main flow.
